(19) United States
(12) Patent Application Publication
(10) Pub. No.: US 2008/0223959 A1
(43) Pub. Date: Sep. 18, 2008

(54) Injection Valve

(76) Inventor: Michael Kurz, Plochingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/997,791

(22) PCT Filed: Jun. 6, 2006
(86) PCT No.: PCT/EP06/62918

§ 371 Date: Feb. 4, 2008

(30) Foreign Application Priority Data
Aug. 3, 2005 (DE) 102005036444.6

(51) Int. Cl. F02M 61/16

(52) U.S. Cl. 239/533.5

(57) ABSTRACT

The present invention relates to an injection nozzle for an internal combustion engine in a motor vehicle. A nozzle body has at least one spray hole, a nozzle needle mounted in the nozzle body with adjustable stroke for controlling an injection of fuel through the at least one spray hole. A booster piston is drive-coupled to an actuator and has a booster face which delimits a booster chamber. According to the invention, the nozzle needle has a control face which delimits a control chamber. In order to dampen the movement of the nozzle needle into its needle seat as the nozzle needle closes, a damping piston is arranged in the nozzle body with an adjustable stroke. The damping piston separates the control chamber from the booster chamber. A damping path is provided in the damping piston to hydraulically connect the control chamber to the booster chamber in a throttled manner.

### PRIOR ART

The present invention relates to an injection nozzle for an internal combustion engine, in particular in a motor vehicle, having the characteristics of the preamble to claim 1.

One such injection nozzle is known for instance from German Patent Disclosure DE 10 2005 007 542, filed on Feb. 18, 2005, and includes a nozzle body which has at least one injection port and in which a nozzle needle is supported with an adjustable stroke, with which needle the injection of fuel through the at least one injection port can be controlled. A booster piston is also provided, which is drive-coupled with an actuator and has a booster face that defines a booster chamber. The nozzle needle, or a needle combination that includes the nozzle needle, moreover has a control face that defines a control chamber. In the known injection nozzle, a deflection piston is supported with an adjustable stroke in the booster piston and has a deflection face coupled hydraulically with the booster face. The deflection piston also has a storage face, which defines a storage chamber embodied in the booster piston. In an outset state, in which the nozzle needle blocks the at least one injection port, the deflection piston rests on a stop that is stationary relative to the nozzle body. In the known injection nozzle, the opening motion of the nozzle needle can be subdivided in this way into two phases, which operate with different boosting ratios. At a short opening stroke of the nozzle needle, the deflection piston remains at its stop, and so the stroke of the booster piston moves only the booster face. At a predetermined switching stroke of the nozzle needle, the forces engaging the deflection face of the deflection piston are greater than the forces that engage the storage face of the deflection piston. As a consequence, the deflection piston then lifts away from its stop and thereby moves in the same direction as the booster piston. The stroke of the booster piston consequently moves both the booster face and the deflection face in the same direction. Accordingly, upon an opening actuation, the boosting ratio varies, specifically in such a way that the nozzle needle moves faster in the second phase.

The known injection nozzle operates with direct needle control. This means that the nozzle needle or the needle combination has at least one pressure step, which is hydraulically coupled with a feed path that supplies fuel at injection pressure to the at least one injection port. While opening forces can be introduced into the nozzle needle or the needle combination via the at least one pressure step, closing forces can be introduced into the nozzle needle or the needle combination via the control face. When the nozzle needle is closed, the closing forces predominate. For opening the nozzle needle, the pressure engaging the control face is lowered, and as a result the closing forces are reduced, so that the opening forces predominate. As a consequence, the nozzle needle lifts away and opens the at least one injection port. The pressure reduction at the control face is attained by means of an actuation of the actuator and thus by means of a stroke of the booster piston, since by the stroke of the booster piston at its booster face, a pressure drop is generated that is propagated to the thus hydraulically coupled control face.

In order to attain predetermined injection courses as exactly and replicably as possible with the aid of the injection nozzle, it is advantageous to decouple the stroke course of the opening needle extensively from a voltage course of the actuator, which is preferably designed as a piezoelectric actuator. This is because on the one hand, a time-dependent drift can be observed between the ratio of voltage to actuator stroke, while on the other hand, a tolerance-dictated variation in the ratio of voltage to actuator is unavoidable.

For achieving exact injection courses, the attainment of short closing times for the nozzle needle has added significance. Short closing times can be attained by means of a high closing speed of the nozzle needle. However, to avoid high stress on the nozzle needle upon closure, or in other words as it moves into the needle seat, braking of the nozzle needle before it moves into the needle seat is desirable.

### ADVANTAGES OF THE INVENTION

The injection nozzle of the invention, having the characteristics of the independent claim, has the advantage over the prior art that at least the closing motion of the nozzle needle is subdivided into two phases. During the first phase, the damper piston moves along with it, and thus a direct transmission of pressure between the booster face and the control face takes place. The second phase begins as soon as the damper piston stops moving. In the second phase, the hydraulic coupling between the booster face and the control face is effected via the throttled damping path. In this way, the closing motion of the nozzle needle in the second phase is damped or sharply braked. The nozzle needle thus moves into its needle seat at reduced speed. The load on the nozzle needle is reduced as a result. At the same time, during the first phase of its closing motion, the nozzle needle can be adjusted very quickly, so that in a short time a relatively large portion of its closing stroke can be executed. The braked second phase of motion is then effected in what remains of the closing stroke. The overall result is that relatively short closing times for the nozzle needle can be achieved.

With this construction, the opening motion of the nozzle needle can advantageously be subdivided into two phases as well. During the first phase, the damper piston moves along with the nozzle needle; a faster onset of opening for the nozzle needle is the result, which reduces the dwell time of the nozzle needle in a region with seat throttling. Because of the braking of the nozzle needle in the second phase of the opening motion, the injection quantity during the ignition delay can be reduced. In combination with the fast opening onset, this leads to a reduction in NOₓ emissions.

An embodiment in which the damping path has a damper conduit that penetrates the damper piston and the damper conduit hydraulically connects the booster chamber with the control chamber in throttled fashion is especially advantageous. This damper conduit may include or be designed as a throttle restriction. In this way, the damping path is integrated into the damper piston. At the same time, the damping path or throttling action can thus be defined relatively precisely.

Further important characteristics and advantages of the injection nozzle of the invention will become apparent from the dependent claims, the drawings, and the associated description in conjunction with the drawings.

### DRAWINGS

Exemplary embodiments of the injection nozzle of the invention are shown in the drawings and will be described in further detail below. The drawings, in each case schematically, show the following:

FIG. 1, a highly simplified basic illustration of an injection nozzle according to the invention, in longitudinal section;

FIG. 2, a graph of the needle stroke of the injection nozzle of the invention over time.

### DESCRIPTION OF THE EXEMPLARY EMBODIMENTS

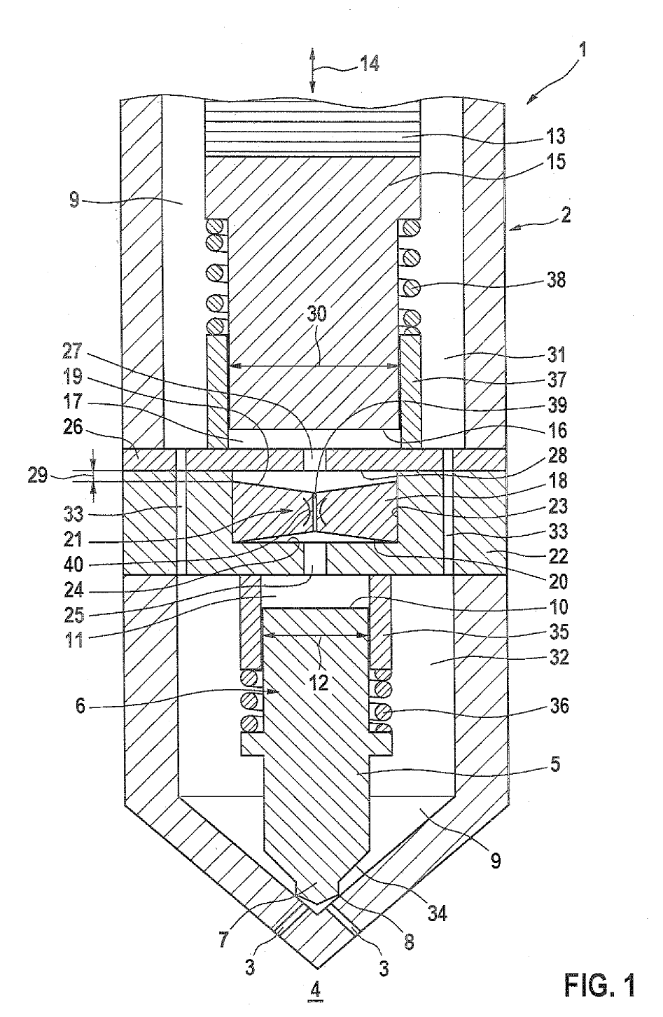

As shown in FIG. 1, an injection nozzle 1 of the invention includes a nozzle body 2, which has at least one injection port 3. The injection nozzle 1 is intended for an internal combustion engine, which may in particular be disposed in a motor vehicle, and serves to inject fuel into an injection chamber 4, into which the injection nozzle 1 in the installed state protrudes, at least in the region of the at least one injection port 3.

The injection nozzle 1 includes a nozzle needle 5, which may be a component of a needle combination 6, and with the aid of which an injection of fuel through the at least one injection port 3 can be controlled. To that end, the nozzle needle 5 with its needle tip 7 cooperates with a needle seat 8. If the nozzle needle 5 is seated in its needle seat 8, the at least one injection port 3 is blocked; that is, the at least one injection port 3 is disconnected from a feed path 9 by way of which fuel at injection pressure is furnished and supplied to the at least one injection port 3. In a common rail system, the feed paths 9 of a plurality of injection nozzles 1 are connected to a common high-pressure fuel line.

The nozzle needle 5 or needle combination 6 is supported with an adjustable stroke in the nozzle body 2 and is equipped with a control face 10 that defines a control chamber 11. This control face 10 has a control face cross section 12, which is represented by a double arrow in FIG. 1.

The injection nozzle 1 is furthermore equipped with an actuator 13, which is preferably designed as a piezoelectric actuator. This kind of actuator 13 can change its length as a function of the current supplied to it. The stroke direction of the actuator 13 is represented in FIG. 1 by a double arrow 14. With increasing current supplied to it, the actuator 13 increases in length and as a result executes a stroke in the direction of the nozzle needle 3. With a decreasing supply of current, also called terminal current supply, the actuator 13 contracts and as a result executes a stroke oriented away from the nozzle needle 5. A booster piston 15 is drive-coupled to the actuator 13. In particular, the actuator 13 and booster piston 15 are solidly joined together. Accordingly, the booster piston 15 follows along with the stroke of the actuator 13. The double arrow 14 thus also represents the stroke adjustment of the booster piston 15. The booster piston 15 has a booster face 16, which defines a booster chamber 17.

The cross section of the booster face 16 is marked 30 in FIG. 1 and represented by a double arrow. The ratio of the booster face 16 to the control face 10 yields a boosting ratio that is operative between the stroke 14 of the booster piston 15 and the needle stroke 5.

The injection nozzle 1 of the invention is furthermore equipped with a damper piston 18, which is disposed with an adjustable stroke inside the nozzle body 2. This damper piston 18 separates the control chamber 11 from the booster chamber 17. Consequently, the damper piston 18 on the one hand, with a first damper face 19, defines the booster chamber 17, while on the other, with a second damper face 20, it defines the control chamber 11. The injection nozzle 1 of the invention furthermore includes a damping path 21, by way of which the control chamber 11 and booster chamber 17 are made to communicate hydraulically with one another in throttled fashion.

The nozzle body 2 is equipped with a spacer plate 22, which is inserted into the nozzle body 2. The spacer plate 22 includes a damper cylinder 23, in which the damper piston 18 is supported with an adjustable stroke. The stroke directions of the booster piston 15, nozzle needle 5 and damper piston 18 are parallel to one another and in particular are oriented coaxially. The damper plate 22 is provided on one side, in this case the side toward the nozzle needle 5, with a first stop 24. This first stop 24 defines the stroke adjustment of the damper piston 18 in one stroke direction, in this case in the stroke direction that leads to the nozzle needle 5. The first stop 24 is formed here by a bottom that axially defines the damper cylinder 23 and that has a central opening 25, which connects the region of the control chamber 11 located inside the damper cylinder 23 with the region of the control chamber 11 located outside the damper cylinder 23.

The nozzle body 2 is furthermore equipped with an intermediate plate 26, which is likewise inserted into the nozzle body 2. This intermediate plate 26 rests axially on the spacer plate 22, specifically in such a way that the intermediate plate 26 forms a cap that axially defines the damper cylinder 23. This cap includes a central opening 27, which connects the region of the booster chamber 17 located inside the damper cylinder 23 with the region of the booster chamber 17 located outside the damper cylinder 23. By means of this cap function, a second stop 28 is embodied on the intermediate plate 26; this stop defines the stroke adjustment of the damper piston 18 in the other stroke direction, in this case the stroke direction oriented toward the booster piston 15. The stroke that can be executed by the damper piston 18 inside the damper cylinder 23 between the two stops 24 and 28 is marked 29 in FIG. 1 and will hereinafter be called the switching stroke. The intermediate plate 26 is disposed such that it rests on the side of the spacer plate 22 facing toward the booster piston 15.

Inside the feed path 9, the spacer plate 22 and the intermediate plate 26 separate a booster region 31 from a needle region 32. In the booster region 31, the booster piston 15 and the actuator 13 are disposed, in such a way that they are bathed by the fuel, resulting in a floating disposition or support for the actuator 13 and the booster piston 15. In the needle region 32, the nozzle needle 5 or the needle combination 6 is disposed, again in such a way that at least part of the needle combination 6 is bathed by the fuel. To this extent, here as well the result is a floating support or disposition for the nozzle needle 5 or needle combination 6. The feed path 9 extends through the spacer plate 22 and through the intermediate plate 26, which is implemented by means of appropriate connection conduits 33. In the needle region 32, the nozzle needle 5 or needle combination 6 has at least one pressure step 34, which is operative in the opening direction of the nozzle needle 5.

In the needle region 32, a control chamber bush 35 is disposed, which is supported with an adjustable stroke on the outside of the nozzle needle 5 or needle combination 6 and circumferentially defines the control chamber 11. This control chamber bush 35 thus separates the control chamber 11 from the feed path 9. A closing compression spring 36 is furthermore provided, which is braced on one end on the control chamber bush 35 and on the other on the nozzle needle 5 or needle combination 6. The closing compression spring 36 drives the nozzle needle 5 into its needle seat 8 on the one hand and on the other forces the control chamber bush 35 into contact with the spacer plate 22, so that the control chamber bush 35 rests permanently against the spacer plate 22.

A booster chamber bush 37 is also provided, which is disposed in the booster region 31 and is supported with an adjustable stroke on the outside of the booster piston 15. The booster chamber bush 37 defines the booster chamber 17 circumferentially and as a result separates it from the feed path 9. With the aid of an opening compression spring 38, the booster chamber bush 37 is prestressed into contact with the intermediate plate 26, in such a way that the booster chamber bush 37 permanently contacts the intermediate plate 26. The opening compression spring 38 is braced on one end on the booster chamber bush 37 and on the other on the booster piston 15.

The damping path 21 is formed here by a damper conduit 39, which penetrates the damper piston 18. The damper conduit 39 is dimensioned such that it hydraulically connects the booster chamber 17 with the control chamber 11 in throttled fashion. For that purpose, the damper conduit 39 preferably includes a throttle restriction 40 or is itself designed as a throttle restriction 40. In the exemplary embodiment shown, the damper conduit 39 is disposed centrally in the damper piston 18 and is axially oriented. A plurality of damper conduits 39 is equally possible, as are orientations or dispositions that deviate from the axial orientation and the central disposition. Instead of a damper conduit 39, the damping path 21 may in principle also be implemented by means of radial play between the damper piston 18 and the damper cylinder 23.

The injection nozzle 1 of the invention functions as follows:

In the outset state show, the nozzle needle 5 is seated in its needle seat 8 and separates the at least one injection port 3 from the feed path 9. The actuator 13 is supplied with current or charged, and the booster piston 15 has its maximum closing stroke, at which it is adjusted in the direction of the nozzle needle 5. Accordingly, the injection nozzle 1 operates with an inversely driven actuator 13, which is supplied with current or charged in order to close the nozzle needle 5. The damper piston 18 in the outset state, with the nozzle needle 5 closed, is also located in the terminal position near the nozzle needle 5 and rests on its first stop 24.

In this outset state, the high fuel pressure, that is, the injection pressure, that also prevails in the feed path 9 prevails in the control chamber 11 and in the booster chamber 17. This is achieved by means of targeted leakage, and in particular by means of radial play between the booster chamber bush 37 and the booster piston 15, on the one hand, and the control chamber bush 35 and the nozzle needle 5 or needle combination 6, on the other.

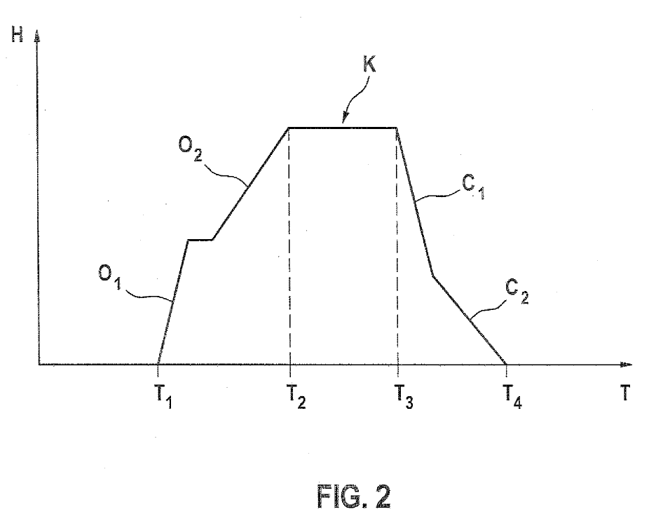

FIG. 2 shows a graph of the needle stroke over time; the needle stroke H is plotted on the ordinate, and the time T is plotted on the abscissa. The graph includes a course curve K, which represents the relationship between the needle stroke H and the time T in the opening and closure of the nozzle needle 3.

At a time T₁, the current is withdrawn from the actuator 13, causing it to contract and carry the booster piston 15 with it. Accordingly, the booster piston 15 executes an opening stroke oriented away from the nozzle needle 5. As a result, the booster chamber 17 increases in size, which is associated with a pressure drop in the booster chamber 17. As a consequence, a pressure difference prevails between the damper faces 19 and 20 of the damper piston 18. The damper piston 18 therefore follows along with the booster piston 15 and lifts away from its first stop 24. As a consequence, the control chamber 11 is now increased in size, which leads to a pressure drop at the control face 10. Since the injection nozzle 1 functions with direct needle control, after a corresponding pressure drop at the control face 10 the forces engaging the nozzle needle 5 or needle combination 6 in the opening direction predominate, and the nozzle needle 5 lifts out of its seat 8. In this first opening phase, marked O₂ in FIG. 2, the damper piston 18 can follow the stroke of the booster piston 15 virtually without hindrance and accordingly carry the pressure drop at the booster face 16 essentially undamped onward to the control face 10. The nozzle needle 5 in the first opening phase O₁ accordingly moves at a relatively high speed out of its needle seat 8. This can be seen in FIG. 2 from the fact that the curve course K in this first opening phase O₁ has a relatively great positive slope, which depends on the particular boosting ratio.

As soon as the damper piston 18 has reached its switching stroke 29, it rests on its second stop 28 and can no longer follow along with the further opening motion of the booster piston 15. The pressure drop that then develops in the booster chamber 17 can now be transmitted to the control chamber 11 via the damping path 21 only in throttled fashion. As a consequence, the nozzle needle 5 can now follow the opening stroke of the booster piston 15 only at a correspondingly slower speed. This second phase of the opening motion is marked O₂ in FIG. 2. In this second opening phase O₂, the course curve K has a lesser positive slope.

Although the effective geometric boosting ratio between the booster face 16 and the control face 10 remains the same during the entire opening motion, the hydraulic coupling via the damping path 21 upon attainment of the switching stroke 29 leads to a change in the hydraulic boosting ratio, since the pressure equilibrium between the booster chamber 17 and the control chamber 11, once the switching stroke is reached, now takes place only in throttled fashion. The switching stroke 29 is accordingly selected such that the damper piston 18 reaches this switching stroke 29 before the nozzle needle 5 has reached its maximum opening stroke. Preferably, this switching stroke 29 is intentionally selected such that the damper piston 18, upon opening of the nozzle needle 5, reaches this stitching stroke 29 as soon as the nozzle needle 5 has moved far enough out of its needle seat 8 that any seat throttling is negligible. This kind of seat throttling occurs at small spacings between the needle tip 7 and the needle seat 8, since because of its construction, the nozzle needle 9 forms a gap upon opening that increases in size with an increasing stroke. If the gap width is small, a throttling action ensues, which hinders the injection. The choice of the switching stroke 29 thus leads relatively quickly out of the critical opening range of the nozzle needle 5.

For example, the switching stroke 29 may be selected such that upon opening of the nozzle needle 5, the damper piston 18 reaches the switching stroke 29 when the nozzle needle 5 has reached between 25 and 75%, or between 30 and 70%, or between 40 and 60%, or approximately 50%, of its maximum opening stroke.

The opening event is terminated at a time T₂. At that time the nozzle needle 5 has then reached its maximum opening stroke, which may be defined for instance by a stop. The opening motion of the booster piston 15 is reinforced by the opening compression spring 38.

For closing the nozzle needle 5, the actuator 13 is again supplied with current at a time T₃. As a consequence, the actuator 13 elongates in the direction of the nozzle needle 5 and as a result drives the booster piston 15, with its booster face 16, so as to decrease the size of the booster chamber 17. The pressure in the booster chamber 17 consequently rises. As soon as the pressure in the booster chamber 17 exceeds the pressure in the control chamber 11, the balance of forces at the damper piston 18 changes again. As a consequence, the damper piston 18 lifts from its second stop 28 and moves in the direction of the nozzle needle 5. In this first closing phase marked C₁ in FIG. 2, the damper piston 18 moves essentially undamped and as a result can transmit the pressure increase in the control chamber 17 virtually without throttling to the control chamber 11. Accordingly, via the increasing force at the control face 11, the nozzle needle 5 is driven in the closing direction. Since in this first closing phase C₁ the damper piston 18 moves with the booster piston 15, the geometric boosting ratio between the booster face 16 and the control face 10 is operative in unthrottled fashion, and as a result the course curve K in the first closing phase C₁ has a correspondingly steep negative slope.

As soon as the damper piston 18 has executed its switching stroke 29, it rests again on the first stop 24. As a consequence, the hydraulic coupling between the booster face 16 and the control face 10 by the damping path 21 is throttled, and the pressure increase in the booster chamber 17 can now be transmitted only in correspondingly damped fashion to the control chamber 1. As a consequence, the nozzle needle 5 is sharply braked. This closing phase is marked C₂ in FIG. 2. The reduced negative slope of the course curve K in the second closing phase C₂ is apparent. As a result of the reduced needle speed, the nozzle needle 5 moves in sharply braked fashion into its needle seat 5, which occurs at time T₄. The closing motion of the nozzle needle 5 is reinforced by the closing compression spring 36.

The injection nozzle 1 thus functions with direct needle control, since in the feed path 9, the injection pressure already prevails, and the opening of the nozzle needle 5 can be initiated by means of a pressure drop in the booster chamber 17 or in the control chamber 11.

The switching stroke 29 is thus adapted in a practical way such that the damper piston 18, upon closure of the nozzle needle 5, reaches this switching stroke 29 securely before the nozzle needle 5 moves into its needle seat 8. This switching stroke 29 may for instance be selected such that the damper piston 18, upon closure of the nozzle needle 5, reaches this switching stroke 29 when the nozzle needle 5 reaches between 25 and 75%, or between 30 and 70%, or between 40 and 60%, or approximately 50%, of its maximum closing stroke.

The embodiment shown here of the injection nozzle 1 may be realized in relatively compact fashion, since the two damper faces 19, 20 are each the same size or approximately the same size as the booster face 16.

The injection nozzle 1 of the invention makes rapid opening of the nozzle needle 5 possible and furthermore assures a comparatively gentle movement into the needle seat 8 upon closure of the nozzle needle 5. It is worth noting that with the aid of the damper piston 8 and the damping path 21, both in the opening stroke and in the closing stroke of the nozzle needle 5, in the first phase a high boosting ratio is operative, which in the second phase is damped or throttled.

1-10. (canceled)

11. An injection nozzle for an internal combustion engine, in particular in a motor vehicle, the injection nozzle comprising:
a nozzle body having at least one injection port;
a nozzle needle supported with an adjustable stroke in the nozzle body, the nozzle needle controlling an injection of fuel through the at least one injection port;
a booster piston drivingly coupled to an actuator, the booster piston having a booster face which defines a booster chamber;
the nozzle needle, or a needle combination including the nozzle needle, having a control face which defines a control chamber;
a damper piston disposed in the nozzle body, the damper piston having an adjustable stroke and separating the control chamber from the booster chamber; and
a damping path provided in the damper piston, the damping path hydraulically connecting the booster chamber with the control chamber in a throttled manner.

12. The injection nozzle according to claim 11, wherein the stroke executed by the damper piston is limited to a predetermined switching stroke that is selected such that the damper piston, upon closure of the nozzle needle, reaches the switching stroke before the nozzle needle moves into its needle seat.

13. The injection nozzle according to claim 12, wherein the switching stroke is selected such that the damper piston, upon closure of the nozzle needle, reaches the switching stroke when the nozzle needle has reached between 40 and 60% of its maximum closing stroke.

14. The injection nozzle according to claim 12, wherein the switching stroke is moreover selected such that the damper piston, upon opening of the nozzle needle, reaches the switching stroke before the nozzle needle has reached its maximum opening stroke.

15. The injection nozzle according to claim 13, wherein the switching stroke is moreover selected such that the damper piston, upon opening of the nozzle needle, reaches the switching stroke before the nozzle needle has reached its maximum opening stroke.

16. The injection nozzle according to claim 12, wherein the switching stroke is selected such that the damper piston, upon opening of the nozzle needle, reaches the switching stroke when the nozzle needle has reached between 40 and 60% of its maximum opening stroke.

17. The injection nozzle according to claim 13, wherein the switching stroke is selected such that the damper piston, upon opening of the nozzle needle, reaches the switching stroke when the nozzle needle has reached between 40 and 60% of its maximum opening stroke.

18. The injection nozzle according to claim 14, wherein the switching stroke is selected such that the damper piston, upon opening of the nozzle needle, reaches the switching stroke when the nozzle needle has reached between 40 and 60% of its maximum opening stroke.

19. The injection nozzle according to claim 11, wherein the damper piston has a first damper face defining the booster chamber, and a second damper face defining the control chamber.

20. The injection nozzle according to claim 19, wherein the damper faces are of equal size.

21. The injection nozzle according to claim 19, wherein at least one of the damper faces is the same or approximately the same size as the booster face.

22. The injection nozzle according to claim 20, wherein at least one of the damper faces is the same or approximately the same size as the booster face.

23. The injection nozzle according to claim 11, further comprising:
a spacer plate inserted into the nozzle body;
a damper cylinder embodied in the spacer plate of the nozzle body, the damper piston being supported with an adjustable stroke in the damper cylinder, the spacer plate defining the adjustable stroke in a first direction;
a control chamber bush being supported with an adjustable stroke on the nozzle needle or on the needle combination, wherein the control chamber bush defines the control chamber on its circumference.

24. The injection nozzle according to claim 11, further comprising:
an intermediate plate inserted into the nozzle body, the intermediate plate defining the adjustable stroke of the damper piston in a second direction;
a booster chamber bush being supported with an adjustable stroke on the booster piston, wherein the booster chamber bush defines the booster chamber on its circumference.

25. The injection nozzle according to claim 23, further comprising:
an intermediate plate inserted into the nozzle body, the intermediate plate defining the adjustable stroke of the damper piston in a second direction;
a booster chamber bush being supported with an adjustable stroke on the booster piston, wherein the booster chamber bush defines the booster chamber on its circumference.

26. The injection nozzle according to claim 11, wherein the damping path has at least one damper conduit penetrating the damper piston, the damper conduit hydraulically connecting the booster chamber with the control chamber in a throttled manner.

27. The injection nozzle according to claim 19, wherein the damping path has at least one damper conduit penetrating the damper piston, the damper conduit hydraulically connecting the booster chamber with the control chamber in a throttled manner.

28. The injection nozzle according to claim 11, further comprising:
a feed path embodied in the nozzle body, the feed path delivers fuel at high pressure to the at least one injection port;
a booster region disposed in the feed path, wherein the booster piston and the actuator are disposed floating in the fuel within the booster region; and/or
a needle region disposed in the feed path, wherein the nozzle needle or the needle combination is disposed floating in the fuel within the needle region.

29. The injection nozzle according to claim 28, wherein
the injection nozzle operates with direct needle control, so that in the feed path, the injection pressure prevails, and an actuation of the actuator for opening the nozzle needle causes a pressure drop in the booster chamber; and/or
the injection nozzle operates with an inversely operated actuator, so that for opening the nozzle needle current is withdrawn from the actuator and for closing the nozzle needle current is supplied to the actuator.

30. The injection nozzle according to claim 11, wherein the switching stroke is selected such that the damper piston, upon opening of the nozzle needle, reaches the switching stroke as soon as the nozzle needle has moved so far from its needle seat that any seat throttling is negligible.
